(19) United States
(12) Patent Application Publication
(10) Pub. No.: US 2024/0143507 A1
(43) Pub. Date: May 2, 2024

(54) Method, Computer Program, and Computer System for Prefetching Data During Execution of an Application Program

(71) Applicant: Intel Corporation, Santa Clara, CA (US)

(72) Inventors: Narayan RANGANATHAN, Bangalore (IN); Vamsi SRIPATHI, Hillsboro, OR (US)

(21) Appl. No.: 18/058,882

(22) Filed: Nov. 28, 2022

(51) Int. Cl. G06F 12/0862; G06F 12/0811

(52) U.S. Cl. CPC G06F 12/0862; G06F 12/0811

(57) ABSTRACT

Examples relate to a non-transitory, computer-readable medium, method, and computer system for prefetching data during executing of a computer program. The non-transitory, computer-readable medium comprises machine-readable instructions that, when the program code is executed on a processor, causes the processor to pre-fetch to a processor cache, using data transfer offloading circuitry of the processor, data being accessed by an application program from a main memory of the computer system, and to execute the computer program using the pre-fetched data that is stored in the processor cache.

### BACKGROUND

Scientific applications in the High-Performance Computing (HPC) domain often require efficient CPUs (Central Processing Units) and a high memory bandwidth to improve their respective performance. While CPUs receive significant performance enhancements with each generation through additional cores, wider SIMD (Single Instruction, Multiple Data) units and new ISA (Instruction Set Architecture) extensions among other microarchitectural features, the gains in DRAM (Dynamic Random Access Memory) bandwidth have historically lagged behind the CPU improvements. This leads to a scenario where real-world applications do not achieve expected performance gains, as the speed at which data is fetched from DRAM is often not fast enough to prevent stalls of CPU execution units. This is a well-known observation and is popularly known as “memory wall”.

### BRIEF DESCRIPTION OF THE FIGURES

Some examples of apparatuses and/or methods will be described in the following by way of example only, and with reference to the accompanying figures, in which

FIG. 1a shows a block diagram of an example of a computer system comprising a processor and a main memory;

FIG. 1b shows a flow chart of an example of a method for executing a computer program on a processor;

FIGS. 2a and 2b show schematic diagrams of components of a processor and associated main memory;

FIG. 3 shows a schematic diagram of an example workflow of the proposed CPU+data transfer offloading circuitry pipelining approach;

FIG. 4 shows a table of a performance comparison between a CPU-only and hybrid implementation; and

FIGS. 5 and 6 shows code listings of two example hybrid implementations.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

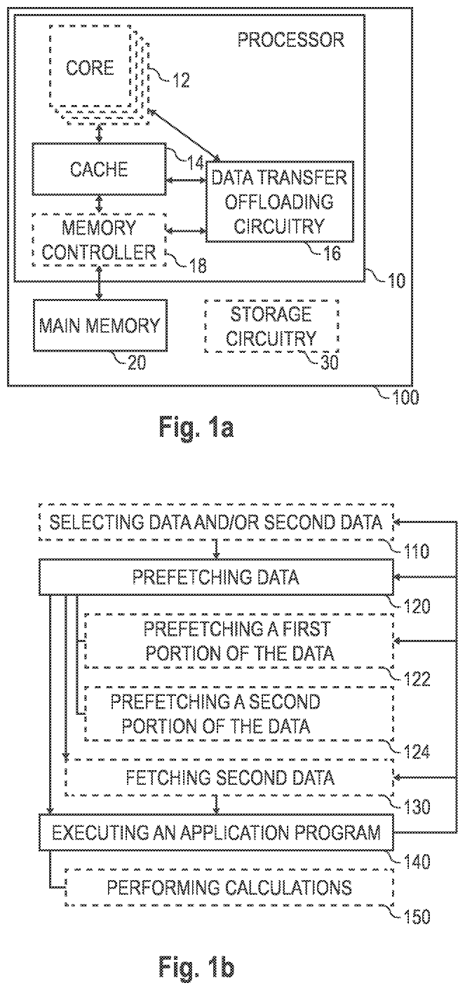

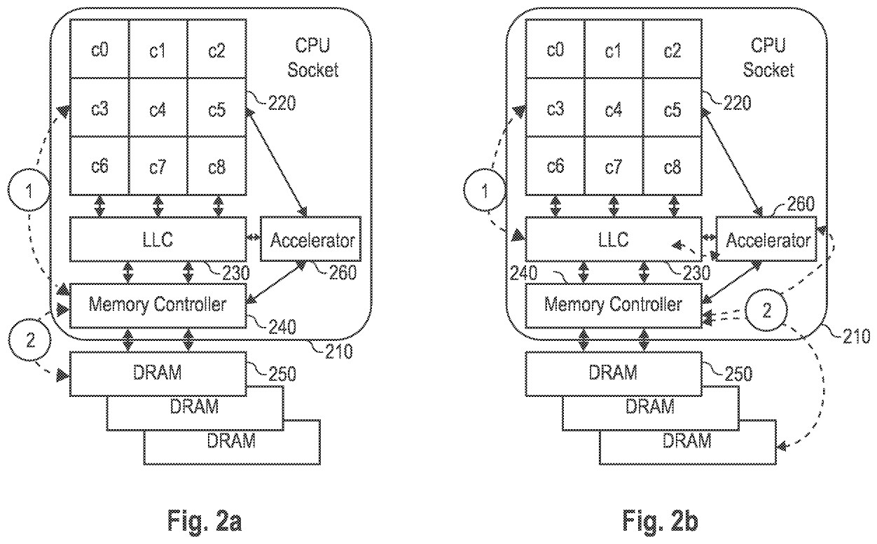

FIG. 1a shows a block diagram of an example of a computer system 100 comprising a processor 10 and a main memory 10. Some aspects of the present disclosure relate to the processor 10, and in particular to the processor 10 executing machine-readable instructions comprising an application program. Some aspects relate to the entire computer system 100.

The processor comprises circuitry to provide the functionality of the processor 10. For example, the circuitry of the processor 10 may be configured to provide the functionality of the apparatus 10, e.g., by machine-readable instructions for instructing the processor to perform the functionality.

For example, the processor 10 may comprise one or more processor cores 12, which may provide the main computational capabilities of the processor 10.

In addition, the processor 12 may comprise various types of additional circuitry (i.e., various controllers), for providing additional functionality. For example, as shown in FIG. 1a, the processor 100 comprises a processor cache 14, which is used to temporarily store (i.e., cache) data being used by the processor. For example, the processor may comprise one or more levels of processor cache 14, e.g., a level 1 (L1) processor cache, a level 2 (L2) processor cache and a level 3 (L3) processor cache, which is the Last-Level Cache (LLC) in the case of three levels of processor cache. In the following, the term “processor cache” is primarily used for the LLC of the processor, which is generally the slowest, but largest cache of the processor. However, in some examples, another level of cache may be used instead.

The processor shown in FIG. 1a further comprises a memory controller 18, which is used to fetch data from the main memory 20 of the computer system 100. The data from the main memory 20 may be provided, by the memory controller 18, to processor registers of the processor being used by the instructions currently being performed by the processor core(s) of the processor 10. In addition, the data may be stored, by the memory controller and/or the processor core(s) in the processor cache 14.

The processor 10 further comprises data transfer offloading circuitry 16, which is circuitry that is separate from the processor core(s), and that provides capabilities related to data transfers being performed by the processor that are offloaded by the processor core(s). In other words, the processor core(s) may instruct the data transfer offloading circuitry 16 to perform the respective data transfers (via the memory controller) without further involving the processor core(s). For example, the data transfers may be performed asynchronously, i.e., without the processor core(s) monitoring the progress of the data transfers. The data transfer offloading circuitry 16 may thus lighten the load of the processor core(s), by performing the data transfers without further involving the processor core(s). For example, in Intel® Xeon® Scalable processors, the data transfer offloading circuitry 16 may correspond to, or implemented by, the Data Streaming Accelerator (DSA). For example, the data transfer offloading circuitry may be operable to load data from the main memory of the computer system via the memory controller 18 of the computer system, and to write data to the processor cache 14.

The respective components of the processor are coupled with each other. For example, as shown in FIG. 1a, the processor core(s) 12 may be coupled with the processor cache 14, with the data transfer offloading circuitry 16, and with the memory controller 18. Similarly, the processor cache 14 may be coupled with the processor core(s), with the data transfer offloading circuitry 16, and with the memory controller 18. The data transfer offloading circuitry may be coupled with the processor core(s) 12, the processor cache 14 and with the memory controller 18.

Above, the components of the processor 10 have been described in terms of circuitry being used to implement the respective functionality. However, the proposed concept is not limited to fixed circuitry providing the respective functionality. In some examples, the processor may be described as a means for processing 10, with component means that are used to provide the respective functionality of the circuitry described above. The components of the means for processing 10 are defined as component means, which may correspond to, or implemented by, the respective structural components of the processor 10. For example, the functionality of the components of the processor 10 may be provided by various means of the means for processing 10. For example, the means for processing 10 may be equipped with means for providing the respective functionality of the components outlined above. Accordingly, in the following, the respective components are described with respect to the respective functionality they provide. For example, the means for processing may comprise, in addition to the core(s) 12 of the means for processing, means for caching information 14, which may be implemented by the processor cache 14, means for data transfer offloading, which may be implemented by the data transfer offloading circuitry, and means for controlling memory 18, which may be implemented by the memory controller 18.

In general, the functionality of the processor 10 or means for processing 10 may be implemented by the processor 10 or means for processing 10 executing machine-readable instructions. Accordingly, any feature ascribed to the processor 10 or means for processing 10 may be defined by one or more instructions of a plurality of machine-readable instructions. The computer system 100, e.g., the processor 10 or means for processing 10, may comprise the machine-readable instructions, e.g., within storage circuitry 30 or means for storing information 30 of the computer system.

FIG. 1b shows a flow chart of an example of a method for executing an application program on a processor, such as the processor 10 or means for processing 10 shown in FIG. 1a. In other words, the processor 10 or means for processing 10 of FIG. 1a may perform the method of FIG. 1b. The method comprises pre-fetching 120 to the processor cache 14 (or means for caching information 14) of the processor, using the data transfer offloading circuitry 16 (or means for data transfer offloading 16) of the processor (or means for processing 10), data being accessed by the application program from the main memory 20 of the computer system. The method comprises executing 140 the application program using the pre-fetched data that is stored in the processor cache.

In the following, the features of the processor 10, means for processing 10, computer system, method and of corresponding machine-readable instructions for controlling the processor 10 or means for processing 10 are described in connection with the method of FIG. 1b. Features introduced in connection with the method may thus likewise be included in the corresponding processor 10, means for processing 10, computer system and corresponding machine-readable instructions.

The present disclosure relates to the execution of an application program (a type of computer program), and in particular to speeding up execution of a application program by prefetching the data being processed by the application program with the help of data transfer offloading circuitry, such as the Data Streaming Accelerator included in the Intel® Xeon® Scalable processors. In other words, the data transfer offloading circuitry of the processor being used to pre-fetch the data may be a data streaming accelerator circuitry of the processor. As outlined above, a major consideration in high-performance computing is the limitation imposed by the memory bandwidth (i.e., the “memory wall”). For example, the aforementioned application program may be a (distributed) application program for performing complex calculations, such as scientific computations, simulations, circuit placement or optimization etc. While both the computational capabilities of the respective processors and the available memory bandwidth increase, the computational capabilities generally increase more than the memory bandwidth, thereby limiting the use of the computational capabilities in real-world use, as the data being processed cannot be loaded fast enough. While some performance bottlenecks can be avoided through the use of processor cache and instruction reordering, many limitations remain.

The proposed concept addresses this bottleneck by using accelerator circuitry available in some advanced processors for data pre-fetching. Instead of (or in addition) to the processor cores pre-fetching data, e.g., via a page-fault mechanism or deliberately, accelerator circuitry (i.e., the data transfer offloading circuitry 16) that is separate from the processor cores are employed to load the data into the processor cache.

Accordingly, the method comprises pre-fetching 120, using data transfer offloading circuitry 16 of the processor to a processor cache 14 of the processor, data being accessed by the application program from a main memory 20 of the computer system, in effect storing the data pre-fetched from the main memory in the processor cache. In particular, the data (and second data, which will be introduced in the following), may be loaded from the Dynamic Random Access Memory (DRAM) of the computer system to a Last-Level Cache or Lower-Level Cache (LLC) of the computer system. In other words, the data may be pre-fetched from the dynamic random-access memory 20 of the computer system and/or prefetched to the LLC 14 of the processor. DRAM, which may be included as High-Bandwidth Memory or via one or more Dual-Inline Memory Modules is often used as main memory of the computer system. The LLC is generally the largest cache of the computer system, providing sufficient space for temporarily storing the data of the application program.

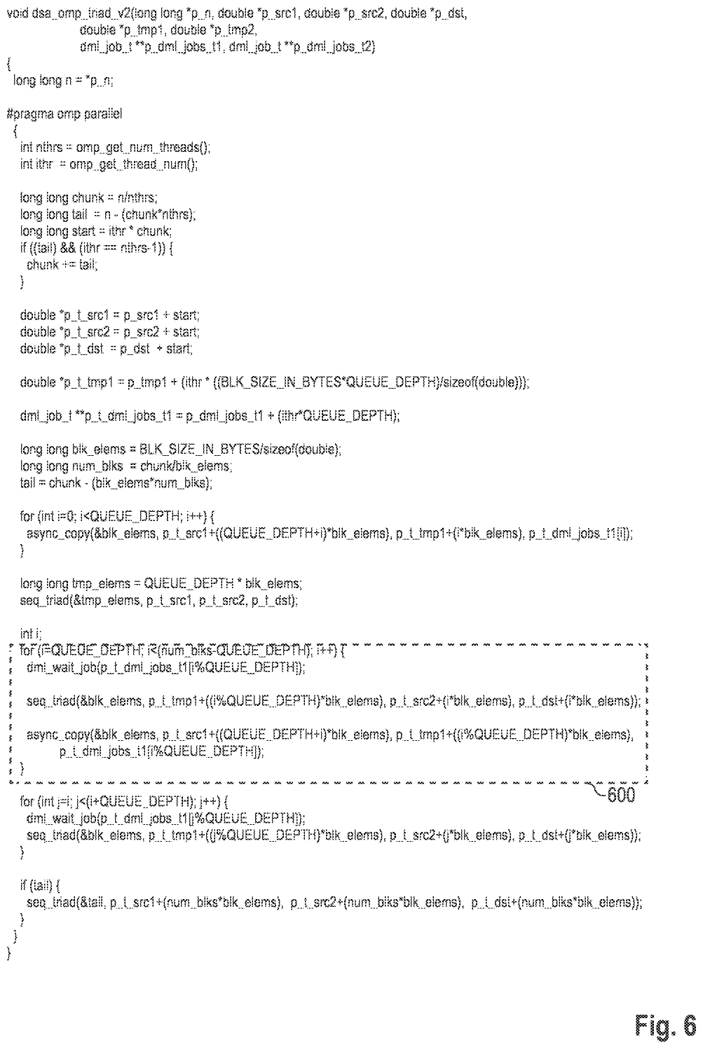

To affect the pre-loading of the data, the application program may be extended with instructions for pre-fetching the data. For example, the pre-fetching of the data by the data transfer offloading circuitry may be defined by instructions included in the application program, e.g., in the machine code of the application program. For example, the (compiled, machine code version of the) application program may comprise instructions for triggering the data transfer offloading circuitry to pre-fetch the data to the processor cache. This may be done explicitly, e.g., by including the respective programming statements in the source code, as shown in FIG. 5 and FIG. 6. Alternatively, this may be done by a runtime being used to execute the application program or by a framework being used in the application program. In other words, in the case of a runtime, the source code or intermediate representation of the application program may be extended, during interpretation or compilation to machine code, with instructions for pre-loading the data, so that the machine-code of the application program being executed by the application program comprises instructions for pre-fetching the. The method may thus comprise interpreting or compiling the application program to (native) machine code and inserting instructions for pre-fetching the data into the machine code. Alternatively, the application program may use a programming framework for fetching the data. During compilation of the application program, if the application program is compiled for a processor architecture comprising data transfer offloading circuitry, instructions for pre-fetching the data may be inserted into the machine code as defined by the programming framework. In some examples, multi-versioning may be used to include a first compiled version of the respective portion of the application program that supports data transfer offloading circuitry-based pre-fetching, and a second compiled version that does not. As a third alternative, explicit instructions for pre-fetching the data may be included in the source code of the application program.

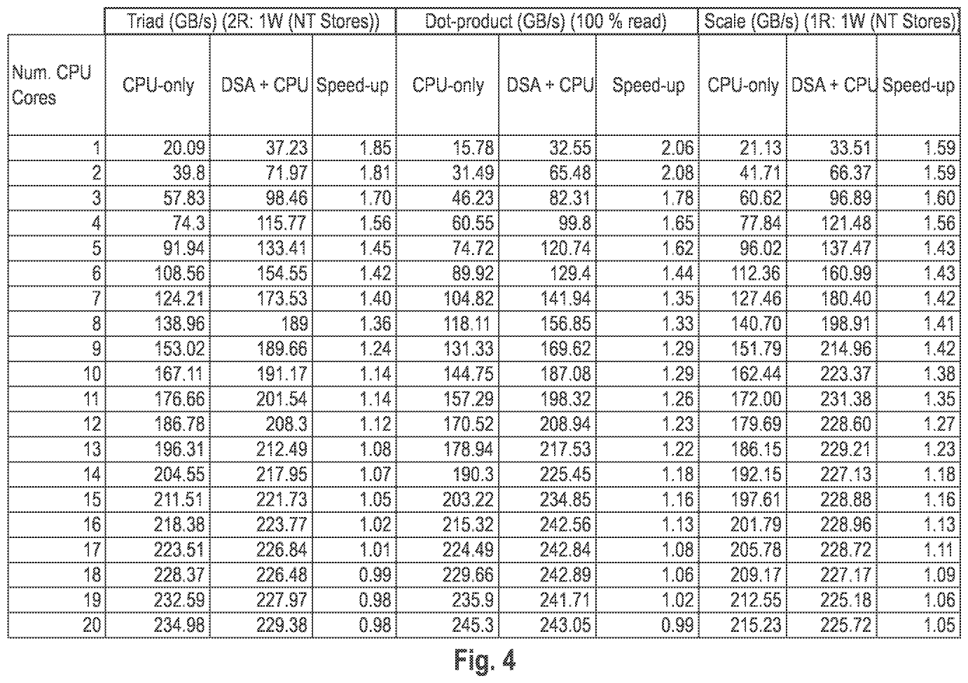

In general, the processor cache, which as a lower access latency and a higher data transmission bandwidth for access by the processor cores than the main memory, has a very limited size, which makes the available space very valuable. Therefore, the pre-fetching of the data may be done in a manner that avoids unnecessarily blocking valuable space within the processor cache. For example, pre-fetching of the data and the execution of the application program may be synchronized, e.g., so that a sufficient (but not too large) amount of data is pre-fetched. The amount of data being pre-fetched may be chosen such, that page faults are avoided while the amount of space in the processor cache being occupied by the pre-fetched data is kept low. For example, as illustrated in connection with FIG. 3, a ring buffer-like data structure may be used to pre-fetch the data. As the application program performs calculations on the data, it may iterate over the blocks of the ring buffer. As soon as the processor is finished processing the data stored in a first block of the ring buffer, it may move to the second block and perform calculations stored in the second block of the ring buffer, while the contents of the first block are replaced by newly pre-fetched data. In more general terms, as further shown in FIG. 1b, the method may comprise subsequently pre-fetching 122, 124 a first portion and a second portion of the data from the main memory to the processor cache. The execution of the application program may be based on the pre-fetched first portion of data while the second portion of the data is being pre-fetched and based on the pre-fetched second portion of data after the execution being based on the first portion of data is completed. Through the instructions in the application program, the pre-fetching of the data and the performance of calculations based on the data may be synchronized. Accordingly, the application program may comprise instructions for triggering the pre-fetching 120 of the data by the data transfer offloading circuitry and instructions for performing calculations 145 based on the pre-fetched data. To avoid unnecessary stalls due to blocking operations, asynchronous instructions may be used (async_copy( ) in FIGS. 5 and 6), combined with instructions for checking that the pre-fetching for the next block being used has already finished (dml_wait_job( ) in FIGS. 5 and 6). A sufficiently high queue depth (i.e., number of blocks in the ring buffer) may be used to avoid stalling.

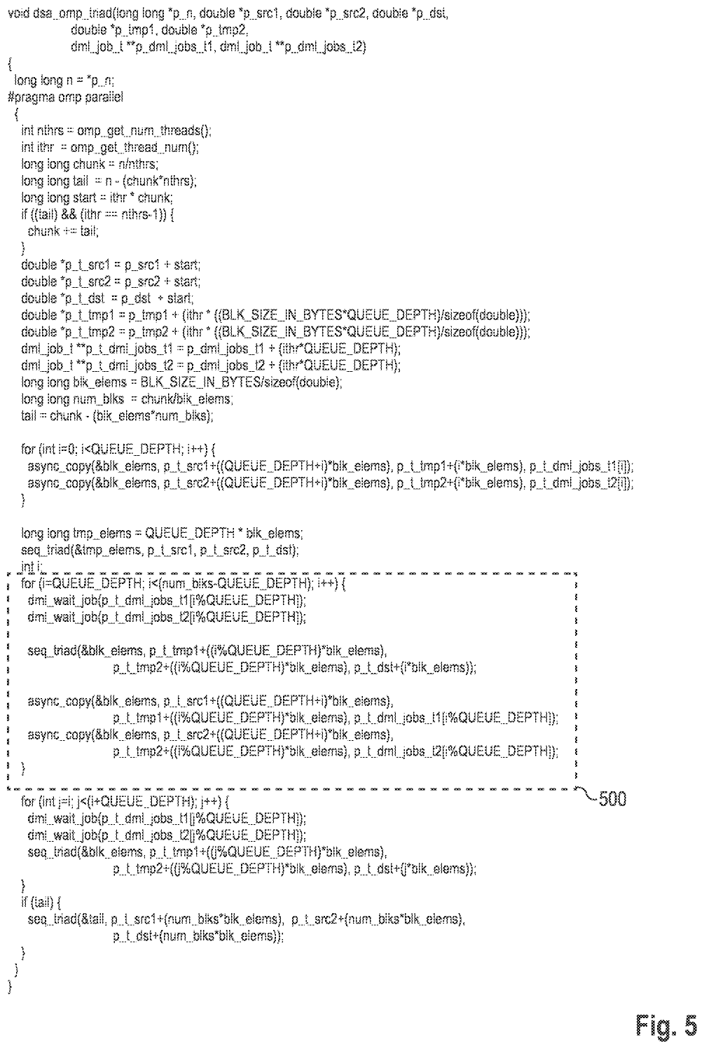

While the use of data transfer offloading circuitry can greatly speed up processing in many scenarios, the number of instances of data transfer offloading circuitry is often lower than the number of processor cores. For example, a processor may have 20, 24, 28, or 32 cores or more, but only four instances of the data transfer offloading circuitry. While the data transfer offloading circuitry may be capable of performing the pre-fetching faster than the core(s) perform their respective calculations, in some cases, at high core counts, the data transfer offloading circuitry may become the bottleneck, as is evident from FIG. 4. At high core counts, the advantage of using data transfer offloading circuitry may diminish compared to no pre-fetching, or sometimes even reverse, as shown in the Triad benchmark. In such cases, only some of the data may be pre-fetched by the data transfer offloading circuitry, while some other data (i.e., the previously mentioned second data) is fetched by the CPU. Therefore, in some examples, the application program may perform calculations not only based on the data, but also on second data. This second data might not be pre-fetched by the data transfer offloading circuitry, but may be fetched (e.g., loaded in response to a page fault, or pre-fetched) by a core of the processor 10. In other words, the method may comprise fetching 130 (e.g., fetching on demand or pre-fetching), using a core 12 of the processor (e.g., the same core processing the data being pre-fetched by the data transfer offloading circuitry), second data being accessed by the application program from the main memory of the computer system to the processor cache of the processor. Accordingly, the application program may comprise first instructions for triggering the pre-fetching 120 of the data by the data transfer offloading circuitry and second instructions for fetching 130 second data using a core of the processor (in the latter case, no additional instructions might be inserted, as the second data may be fetched in response to a page fault). This second data may be fetched in addition to the data being pre-fetched by the data transfer offloading circuitry. In other words, the data being pre-fetched by the data transfer offloading circuitry may be different from the second data being fetched by the core of the processor. For example, the data and second data may be processed simultaneously by the execution of the application program. Alternatively, the data and second data are processed subsequently by the execution of the application program. The core-based fetching of the second data may shift some of the work for fetching the data to the core, which may improve performance both in scenarios where the data and the second data are processed simultaneously and in scenarios where the data and second data are processed subsequently.

The separation of the data and second data has the aim of avoiding scenarios where the data transfer offloading circuitry-based pre-fetching becomes the bottleneck with respect to performance. The distribution of the work of pre-fetching/fetching the data and second data may thus be performed with the objective of avoiding this bottleneck. This distribution may be done by performing a selection, among the overall data being processed by the application program, of the data and the second data. Accordingly, as further shown in FIG. 1b, the method may comprise selecting 110 at least one of the data being pre-fetched by the data transfer offloading circuitry and the second data being fetched by the core of the processor. In other words, the entirety of data being processed by the application program may be divided into the data (being pre-fetched by the data transfer offloading circuitry) and the second data (being loaded by the core of the processor). In various examples, the selection may be based on at least one of a number of concurrent data transfers supported by the data transfer offloading circuitry, a number of computation threads of the application program being executed, and a number of cores of the processor being used for executing the application program. For example, based on the number of concurrent data transfers supported by the data transfer offloading circuitry, an estimation of the time required for performing the data transfers relative to the time required for processing the data, and the number of computation threads (which may be up to the number of (virtual) cores, for example, in scientific calculations), a ratio may be determined as part of the selection process, with the ratio indicating the amount of data to be pre-fetched by the data transfer offloading circuitry and the amount of data being fetched by the core.

Based on the data being pre-fetched (and optionally based on the second data being fetched by a processor core), the application program is executed using the pre-fetched data that is stored in the processor cache. As the data is stored in the processor cache, it may be accessed with a low latency and a high memory bandwidth, avoiding a degradation of performance caused if the data were not already present in the processor cache.

For example, the processor 10 may be one of a central processing unit (CPU), graphics processing unit (GPU), field programmable gate array (FPGA), or application specific integrated circuit (ASIC). In some examples, the processor core(s) 12 of the processor 10 may be core(s) sold or designed by Intel®, ARM®, AMD®, Qualcomm®, Nvidia®, IBM®, Texas Instruments®, among others. The processor cache may comprise one or more cache devices (e.g., level 1 cache (L1), level 2 cache (L2), level 3 cache (L3), lower-level cache (LLC)). The memory controller 18 is a controller, integrated within the processor, for interfacing with the main memory 20 of the computer system. For example, the main memory 20 may be embodied as any type of memory device capable of (temporarily) storing data, such as any type of volatile (e.g., dynamic random-access memory (DRAM), etc.) or non-volatile memory. Volatile memory may be a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM). The processor may comprise interface circuitry (or means for communicating), not shown, for communicating with other components of the computer system, such as the storage circuitry 30. The interface circuitry or means for communicating may correspond to one or more inputs and/or outputs for receiving and/or transmitting information, which may be in digital (bit) values according to a specified code, within a module, between modules or between modules of different entities. For example, the interface circuitry or means for communicating may comprise circuitry configured to receive and/or transmit information. For example, the storage circuitry 30 or means for storing information 30 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

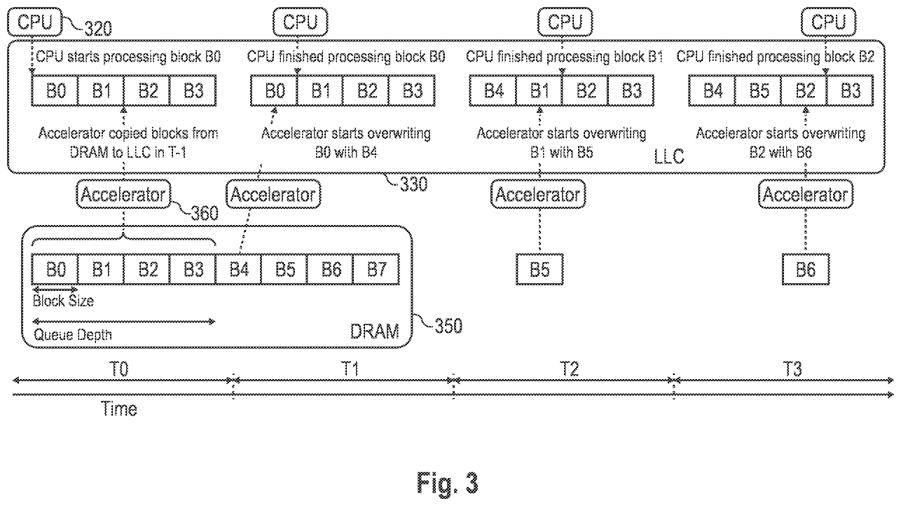

More details and aspects of the computer system, processor, method, and machine-readable instructions are mentioned in connection with the proposed concept, or one or more examples described above or below (e.g., FIGS. 2 to 6). The computer system, processor, method, and machine-readable instructions may comprise one or more additional optional features corresponding to one or more aspects of the proposed concept, or one or more examples described above or below.

Various examples of the present disclosure relate to a concept for data transfer offloading circuitry-based (e.g., Intel® Data Direct Input/Output, DDIO-based) software prefetching with a hybrid Central Processing Unit (CPU)-data transfer offloading circuitry (e.g., Intel® Data Streaming Accelerator) pipeline to improve memory bandwidth. For example, the proposed concept may relate to a previously, automatic acceleration of memory bandwidth bound kernels using hybrid CPU-data transfer offloading circuitry software pipelining.

Various examples of the proposed concept demonstrate that the effects of the memory wall on application performance can be mitigated by employing techniques that uses the strengths of both the CPU and data transfer offloading circuitry of the CPU, such as the Intel® Data Streaming Accelerator (DSA) simultaneously (DSA is available from Intel® 4^{th} generation Xeon® Scalable Processors). By integrating the proposed concept into a run-time library, such as the Math Kernel Library (MKL), they provide an automatic performance boost without requiring code changes in end user applications.

While other concepts also take advantage of technologies for improving I/O (such as Intel® DDIO, this has been done for the purpose of accelerating access to data being sent or received over the PCIe (Peripheral Component Interconnect express) interface. In contrast, the proposed concept tackles the scenario when data is already in DRAM, with the proposed concept being used to improve the application performance in scenarios where the CPU reads data from DRAM, performs arithmetic operations on the data and writes the results back to the DRAM.

Various examples of the present disclosure are based on efficiently overlapping data transfer offloading circuitry data transfers (from DRAM to the Last Level Cache, LLC) with CPU computations being performed on LLC being loaded into CPU registers through asynchronous copies.

Data transfer offloading circuitry, such as the current generation of DSA, often do not support arithmetic operations such as multiply, add or FMA's (fused multiply add), but they may be capable of writing to a configurable portion of the LLC, e.g., 2 out of 15-way LLC (resulting in an effective size=2/15 LLC=14 MB on Intel 4^{th} gen Xeon Scalable Processors). This feature can be exploited to use data transfer offloading circuitry as a prefetcher from DRAM to LLC, with the CPU cores being used for computation operations. Below, high-level components of the proposed hybrid CPU+data transfer offloading circuitry software pipelining implementation are shown.

While the CPU is reading data from the LLC and doing compute operations, the data transfer offloading circuitry may concurrently fetch the next iteration's blocks from DRAM and write them to LLC. Behind the scenes, software pipelining may be used to ensure that the instances of the data transfer offloading circuitry (e.g., four engines in the current generation of DSA, one per sub-NUMA (Non-Uniform Memory Architecture) cluster) are used to achieve peak memory bandwidth. The CPU operations may be parallelized, e.g., using OpenMP (a Message Passing framework) and the data read by various threads may results in hits in the LLC, thereby improving the memory bandwidth performance.

FIGS. 2a and 2b show schematic diagrams of components 220; 230; 240; 260 of a CPU (socket) 210 and associated main memory (DRAM) 250. FIGS. 2a and 2b show the high-level differences between the CPU-only approach compared against the proposed hybrid CPU+data transfer offloading circuitry (e.g., DSA) workflow. In the CPU-only approach, shown in FIG. 2a, tasks (1) and (2) refer to the load/store requests originating from CPU cores 220 for data residing in DRAM 250 and going to the memory controller(s) 240. In the CPU-only approach, the accelerator (data transfer offloading circuitry) 260 is not used, and the data bypasses the LLC 230.

In the CPU+data transfer offloading circuitry approach shown in FIG. 2b, in (1), the CPU cores 220 load data from LLC 230 instead of DRAM 250. Task (2) shows the sequence where the accelerator (data transfer offloading circuitry) 260 initiates the data transfer from DRAM 250 (through memory controller 240) to LLC 230. Tasks (1) and (2) may be performed in a pipelined and asynchronously manner such that the data the CPU (cores) needs to read at time Tₓ is already copied to LLC by the accelerator in T₍ₓ₋₁₎. Task (2) can be further improved by allowing the accelerator to directly have the data to be prefetched into LLC without the accelerator have to read and then write the data. This can result in further efficiency improvement.

In an example implementation, for each CPU thread, a queue depth of 4 with each entry holding 1 MB of data of input buffers was used. So, basically, while CPU is reading 4 MB from the LLC, the data transfer offloading circuitry may fetch the next chunk of 4 MB from DRAM.

FIG. 3 shows a schematic diagram of an example workflow of the proposed CPU+data transfer offloading circuitry pipelining approach for an elementary CPU operation like reading a data array from DRAM. In the present disclosure, the data transfer offloading circuitry (e.g., the Intel® DSA) is used as a custom hardware prefetch engine, complementing the strengths of the data transfer offloading circuitry by using the powerful execution units of CPUs. FIG. 3 shows a sample pipeline of data operations in a hybrid CPU+data transfer offloading circuitry implementation, for 1 buffer with 1 CPU core.

In FIG. 3, a CPU 320, an LLC 330, DRAM 350 and an accelerator (e.g., data transfer offloading circuitry, such as DSA) 360 are shown over a timeline comprising four time intervals T0 to T3. In T−1 (not shown), the accelerator 360 has already copied blocks B0 to B3 from DRAM 350 (comprising blocks B0 to B7) to LLC. In FIG. 3, a block size of 1 block and a queue depth of four blocks was used). In the first time interval TO, the CPU 320 starts processing block B0 that is stored in the LLC. In the second time interval T1, the CPU 320 has finished processing block B0 (and starts processing block B1), and the accelerator 360 starts overwriting B0 with B4 (from DRAM 350). In the third time interval T2, the CPU 320 has finished processing block B1 (and starts processing block B2), and the accelerator 360 starts overwriting B1 with B5 (from DRAM 350). In the fourth time interval T3, the CPU 320 has finished processing block B2 (and starts processing block B3), and the accelerator 360 starts overwriting B2 with B6 (from DRAM 350) etc.

While CPUs also have different hardware prefetchers and ISA support for software driven prefetching, their gains are limited at low core-count regimes. Each CPU core only has a limited number of out-of-order engine capabilities (number of entries of ROB (Re-Order Buffer), MOB (Memory Order Buffer), load/store buffers) and these may become the bottleneck as each memory request occupies the buffer slots for a longer time since the data needs to be fetched from DRAM.

The STREAM: Sustainable Memory Bandwidth in High Performance Computers suite of benchmarks by John D. McCalpin, Ph.D was used for performance evaluations. STREAM is the de-facto industry benchmark used in measuring peak sustained memory bandwidth. It has 4 kernels (Scale, Copy, Add, Triad) representing the following two read:write traffic signatures−scale operations (a[i]=scalar*b[i]), which comprise 1 read+1 write per array element (the write will use non-temporal stores, so there is no read of destination buffer to cache hierarchy), and triad operations (c[i]=a[i]+scalar*b[i]), which comprise 2 reads+1 write per array element. (non-temporal stores).

In addition to the standard STREAM kernels, vector dot-product operations (res+=a[i]*b[i]; All reads, no writes) were also evaluated, as they are commonly encountered operations in many HPC apps.

FIG. 4 shows a table of a performance comparison between a CPU-only and hybrid CPU+DSA implementation. FIG. 4 shows the performance of running these kernels on a 1-socket of Intel 4^{th} generation Xeon Scalable Processor (56-cores, 8-channel DDR5@4800MT/s, theoretical peak b/w is 8ch×8B×4.8 GT/s=307 GB/s). In the experiment, the size of each input buffer was 1 GiB. The memory footprint for the kernels Scale and Dot-product was 2 GiB and Triad was 3 GiB. Each kernel was run 100 times and the best out of 100 trials was reported. The CPU-only implementation relied on CPU cores/threads to perform the operations with OpenMP parallelization. Non-temporal stores (vmovntpd) were used. In the hybrid CPU+DSA implementation, the DSA was used to only fetch the input load buffers from DRAM to LLC and rely on non-temporal stores by the CPU to directly update destination buffers in memory.

The present disclosure demonstrates that the performance of industry-standard memory bandwidth benchmarks can be accelerated by applying hybrid CPU+data transfer offloading circuitry software pipelining techniques. While the implementation described at various points of the present disclosure is using DSA, it should be noted that the proposed concept is also applicable and/or can be extended to other accelerator devices as well.

The proposed concept may increase application performance while using fewer CPU cores. This may lead to a higher performance per cost (e.g., in Cloud deployments) as well as a higher performance per watt. FIG. 4 shows the performance improvements for the current hybrid implementation. When benchmarking the Scale kernel, the performance of a CPUonly approach at 20 cores could be achieved by using only 9 CPU cores+DSA. When benchmarking the Triad kernel, the performance of CPU-only approach at 12 cores could be achieved by using only 8 CPU cores+DSA. When benchmarking the Dot kernel, the performance of the CPU-only approach at 8 cores could be achieved by using only 5 CPU cores+DSA.

In another implementation, heterogeneous applications may be accelerated. For example, a subset of CPU cores and the data transfer offloading circuitry may handle memory-bound tasks, the remaining CPU cores in the socket may be used for more complex compute-bound tasks without negatively impacting application performance. The present concept may further be used for acceleration of single-threaded applications that are bound by memory-bandwidth performance.

The present disclosure may lead to a higher memory bandwidth realized at lower core count regime. In CPU-only approaches, at lower core counts where the available DRAM bandwidth is not yet fully saturated, the memory bandwidth performance is determined by the amount of concurrency achieved (through microarchitectural queue structures). Thus, in CPU-only approaches, more CPU cores are added to drive more concurrent memory requests in the pipelines. The present disclosure provides an alternative approach of using the data transfer offloading circuitry to drive higher performance without having additional CPU cores. This makes CPUs with less powerful and more efficient execution units feasible without degrading application performance, as the data transfer offloading circuitry may be capable of fully saturating the memory bandwidth and the CPU does not require deeper microarchitectural buffers to hide DRAM latency as it is hitting in LLC now. Thus, CPUs may be targeted towards applications that are memory-bound, i.e., CPUs with lesser number of CPU cores without degrading application performance.

In the following, and in FIGS. 5 and 6, two different implementations are shown, which may be used depending up on how many cores are being requested in the application. FIG. 5 shows a code listing of an example implementation, where the data transfer offloading circuitry fetches (all of) the data from memory. FIG. 5 shows a code listing of a first hybrid CPU+data transfer offloading circuitry pipelining implementation of Triad kernel using OpenMP and Intel® Data Mover Library (DML) APIs (Application Programming Interfaces). For example, as shown in highlighted portion 500 of FIG. 5, the two async_copy( ) instructions, which are performed by the data transfer offloading circuitry, are used to prefetch the data from DRAM to the LLC. In FIG. 5, the seq_triad( ) instructions is the instruction processing the data.

At higher thread counts, there is greater contention at data transfer offloading circuitry queues when there are too many outstanding requests. This leads to smaller benefits of the data transfer offloading circuitry-based approach vs. the CPU-only approach, as shown in FIG. 4, or even to less performance. To mitigate this issue, a different implementation may be used so that CPU also handles some memory requests along with data transfer offloading circuitry.

For Triad and Dot, two popular memory bandwidth benchmarks of the STREAM collection of benchmarks by John. D. McCalpin, the CPU is used fetch one of the input buffers (src1) while the data transfer offloading circuitry fetches the other input buffers (src2). FIG. 6 shows an example of this, where, in contrast to FIG. 5, the main loop of the function body has only one async_copy( ) compared to two in FIG. 5. As a result, src2 is loaded by the CPU (via the memory controller), while src1 is loaded by the data transfer offloading circuitry. FIG. 6 shows a code listing of a second hybrid CPU+data transfer offloading circuitry pipelining implementation of Triad kernel using OpenMP and Intel® Data Mover Library (DML) APIs.

This has the benefit of putting the CPU to work instead of just waiting for data transfer offloading circuitry to finish copy from DRAM to LLC. At higher core counts, the CPU is generally too fast since it is just reading from LLC, so the spare capacity can be used to perform some heavy lifting by going to DRAM. This way, the CPU hardware prefetchers may be utilized as well. Since, in this scenario, the data transfer offloading circuitry is only tasked with fetching one buffer from DRAM to LLC, the number of outstanding data transfer offloading circuitry requests are reduced by half. This also reduces the contention at the data transfer offloading circuitry queues,

More details and aspects of the concept for data transfer offloading circuitry-based software prefetching with a hybrid CPU-data transfer offloading circuitry pipeline are mentioned in connection with the proposed concept, or one or more examples described above or below (e.g., FIG. 1a to 1b). The concept for data transfer offloading circuitry-based software prefetching with a hybrid CPU-data transfer offloading circuitry pipeline may comprise one or more additional optional features corresponding to one or more aspects of the proposed concept, or one or more examples described above or below.

In the following, some examples of the proposed concept are presented.

An example (e.g., example 1) relates to a non-transitory, computer-readable medium comprising machine-readable instructions that, when the machine-readable instructions are executed on a processor (10), causes the processor to pre-fetch to a processor cache (14), using data transfer offloading circuitry (16) of the processor (10), data being accessed by an application program from a main memory (20) of the computer system, and to execute the application program using the pre-fetched data that is stored in the processor cache.

Another example (e.g., example 2) relates to a previously described example (e.g., example 1) or to any of the examples described herein, further comprising that the machine-readable instructions comprise instructions to subsequently pre-fetch a first portion and a second portion of the data from the main memory to the processor cache, with the execution of the application program being based on the pre-fetched first portion of data while the second portion of the data is being pre-fetched, and with the execution of the application program being based on the pre-fetched second portion of data after the execution being based on the first portion of data is completed.

Another example (e.g., example 3) relates to a previously described example (e.g., one of the examples 1 to 2) or to any of the examples described herein, further comprising that the data is prefetched to a last-level cache (14) of the processor.

Another example (e.g., example 4) relates to a previously described example (e.g., one of the examples 1 to 3) or to any of the examples described herein, further comprising that the data is pre-fetched from a dynamic random-access memory (20) of the computer system.

Another example (e.g., example 5) relates to a previously described example (e.g., one of the examples 1 to 4) or to any of the examples described herein, further comprising that the machine-readable instructions comprise instructions to pre-fetch, using a core (12) of the processor, second data being accessed by the application program from the main memory of the computer system to the processor cache of the processor.

Another example (e.g., example 6) relates to a previously described example (e.g., example 5) or to any of the examples described herein, further comprising that the data being prefetched by the data transfer offloading circuitry is different from the second data being fetched by the core of the processor.

Another example (e.g., example 7) relates to a previously described example (e.g., one of the examples 5 to 6) or to any of the examples described herein, further comprising that the machine-readable instructions comprise instructions to select at least one of the data being pre-fetched by the data transfer offloading circuitry and the second data being fetched by the core of the processor.

Another example (e.g., example 8) relates to a previously described example (e.g., example 7) or to any of the examples described herein, further comprising that the selection is based on at least one of a number of concurrent data transfers supported by the data transfer offloading circuitry, a number of computation threads of the application program being executed, and a number of cores of the processor being used for executing the application program.

Another example (e.g., example 9) relates to a previously described example (e.g., one of the examples 5 to 8) or to any of the examples described herein, further comprising that the data and second data are processed simultaneously by the execution of the application program.

Another example (e.g., example 10) relates to a previously described example (e.g., one of the examples 5 to 9) or to any of the examples described herein, further comprising that the data and second data are processed subsequently by the execution of the application program.

Another example (e.g., example 11) relates to a previously described example (e.g., one of the examples 1 to 10) or to any of the examples described herein, further comprising that the pre-fetching of the data and the execution of the application program are synchronized.

Another example (e.g., example 12) relates to a previously described example (e.g., one of the examples 1 to 11) or to any of the examples described herein, further comprising that the pre-fetching of the data by the data transfer offloading circuitry is defined by instructions included in the application program.

Another example (e.g., example 13) relates to a previously described example (e.g., one of the examples 1 to 12) or to any of the examples described herein, further comprising that the application program comprises instructions for triggering the pre-fetching of the data by the data transfer offloading circuitry and instructions for performing calculations based on the pre-fetched data.

Another example (e.g., example 14) relates to a previously described example (e.g., example 13) or to any of the examples described herein, further comprising that the application program comprises first instructions for triggering the pre-fetching of the data by the data transfer offloading circuitry and second instructions for pre-fetching second data using a core of the processor.

Another example (e.g., example 15) relates to a previously described example (e.g., one of the examples 1 to 14) or to any of the examples described herein, further comprising that the data transfer offloading circuitry of the processor being used to pre-fetch the data is a data streaming accelerator circuitry of the processor.

An example (e.g., example 16) relates to a method for executing an application program on a processor (10) of a computer system (100), the method comprising pre-fetching (120) to a processor cache (14), using data transfer offloading circuitry (16) of the processor, data being accessed by the application program from a main memory (20) of the computer system. The method comprises executing (140) the application program using the pre-fetched data that is stored in the processor cache.

Another example (e.g., example 17) relates to a previously described example (e.g., example 16) or to any of the examples described herein, further comprising that the method comprises subsequently pre-fetching (122; 124) a first portion and a second portion of the data from the main memory to the processor cache, with the execution of the application program being based on the pre-fetched first portion of data while the second portion of the data is being pre-fetched, and with the execution of the application program being based on the pre-fetched second portion of data after the execution being based on the first portion of data is completed.

Another example (e.g., example 18) relates to a previously described example (e.g., one of the examples 16 to 17) or to any of the examples described herein, further comprising that the data is prefetched to a last-level cache (14) of the processor.

Another example (e.g., example 19) relates to a previously described example (e.g., one of the examples 16 to 18) or to any of the examples described herein, further comprising that the data is pre-fetched from a dynamic random-access memory (20) of the computer system.

Another example (e.g., example 20) relates to a previously described example (e.g., one of the examples 16 to 19) or to any of the examples described herein, further comprising that the method comprises fetching (130), using a core (12) of the processor, second data being accessed by the application program from the main memory of the computer system to the processor cache of the processor.

Another example (e.g., example 21) relates to a previously described example (e.g., example 20) or to any of the examples described herein, further comprising that the data being pre-fetched by the data transfer offloading circuitry is different from the second data being fetched by the core of the processor.

Another example (e.g., example 22) relates to a previously described example (e.g., one of the examples 20 to 21) or to any of the examples described herein, further comprising that the method comprises selecting (110) at least one of the data being pre-fetched by the data transfer offloading circuitry and the second data being fetched by the core of the processor.

Another example (e.g., example 23) relates to a previously described example (e.g., example 22) or to any of the examples described herein, further comprising that the selection is based on at least one of a number of concurrent data transfers supported by the data transfer offloading circuitry, a number of computation threads of the application program being executed, and a number of cores of the processor being used for executing the application program.

Another example (e.g., example 24) relates to a previously described example (e.g., one of the examples 20 to 23) or to any of the examples described herein, further comprising that the data and second data are processed simultaneously by the execution of the application program.

Another example (e.g., example 25) relates to a previously described example (e.g., one of the examples 20 to 24) or to any of the examples described herein, further comprising that the data and second data are processed subsequently by the execution of the application program.

Another example (e.g., example 26) relates to a previously described example (e.g., one of the examples 16 to 25) or to any of the examples described herein, further comprising that the pre-fetching of the data and the execution of the application program are synchronized.

Another example (e.g., example 27) relates to a previously described example (e.g., one of the examples 16 to 26) or to any of the examples described herein, further comprising that the pre-fetching of the data by the data transfer offloading circuitry is defined by instructions included in the application program.

Another example (e.g., example 28) relates to a previously described example (e.g., one of the examples 16 to 27) or to any of the examples described herein, further comprising that the application program comprises instructions for triggering the pre-fetching (120) of the data by the data transfer offloading circuitry and instructions for performing calculations (145) based on the pre-fetched data.

Another example (e.g., example 29) relates to a previously described example (e.g., example 28) or to any of the examples described herein, further comprising that the application program comprises first instructions for triggering the pre-fetching (120) of the data by the data transfer offloading circuitry and second instructions for fetching (130) second data using a core of the processor.

Another example (e.g., example 30) relates to a previously described example (e.g., one of the examples 16 to 29) or to any of the examples described herein, further comprising that the data transfer offloading circuitry of the processor being used to pre-fetch the data is a data streaming accelerator circuitry of the processor.

An example (e.g., example 31) relates to a computer system (100) comprising a main memory (20), machine-readable instructions comprising an application program, and a processor (10) to execute the machine-readable instructions to pre-fetch to a processor cache (14), using data transfer offloading circuitry (16) of the processor (10), data being accessed by the application program from a main memory (20) of the computer system, and to execute the application program using the pre-fetched data that is stored in the processor cache.

An example (e.g., example 32) relates to a computer system (100) comprising a main memory (20) and a processor (10) configured to pre-fetch to a processor cache (14), using data transfer offloading circuitry (16) of the processor (10), data being accessed by an application program from the main memory (20) of the computer system, and to execute the application program using the pre-fetched data that is stored in the processor cache.

An example (e.g., example 33) relates to a computer system (100) for executing an application program, the computer system comprising a main memory (20) and a means for processing (10) for pre-fetching to a means for caching (14), using means for data transfer offloading (16) of the means for processing (10), data being accessed by an application program from the main memory (20) of the computer system, and for executing the application program using the pre-fetched data that is stored in the means for caching.

An example (e.g., example 34) relates to a non-transitory machine-readable storage medium including program code, when executed, to cause a machine to perform the method of one of the examples 16 to 30 or according to any other example.

An example (e.g., example 35) relates to a computer program having a program code for performing the method of one of the examples the method of one of the examples 16 to 30 or according to any other example when the computer program is executed on a computer, a processor, or a programmable hardware component.

An example (e.g., example 36) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory, computer-readable medium comprising machine-readable instructions that, when the machine-readable instructions are executed on a processor, causes the processor to:
pre-fetch to a processor cache, using data transfer offloading circuitry of the processor, data being accessed by an application program from a main memory of the computer system; and
execute the application program using the pre-fetched data that is stored in the processor cache.

2. The non-transitory, computer-readable medium according to claim 1, wherein the machine-readable instructions comprise instructions to subsequently pre-fetch a first portion and a second portion of the data from the main memory to the processor cache, with the execution of the application program being based on the pre-fetched first portion of data while the second portion of the data is being pre-fetched, and with the execution of the application program being based on the pre-fetched second portion of data after the execution being based on the first portion of data is completed.

3. The non-transitory, computer-readable medium according to claim 1, wherein the data is prefetched to a last-level cache of the processor.

4. The non-transitory, computer-readable medium according to claim 1, wherein the data is pre-fetched from a dynamic random-access memory of the computer system.

5. The non-transitory, computer-readable medium according to claim 1, wherein the machine-readable instructions comprise instructions to pre-fetch, using a core of the processor, second data being accessed by the application program from the main memory of the computer system to the processor cache of the processor.

6. The non-transitory, computer-readable medium according to claim 5, wherein the data being pre-fetched by the data transfer offloading circuitry is different from the second data being fetched by the core of the processor.

7. The non-transitory, computer-readable medium according to claim 5, wherein the machine-readable instructions comprise instructions to select at least one of the data being pre-fetched by the data transfer offloading circuitry and the second data being fetched by the core of the processor.

8. The non-transitory, computer-readable medium according to claim 7, wherein the selection is based on at least one of a number of concurrent data transfers supported by the data transfer offloading circuitry, a number of computation threads of the application program being executed, and a number of cores of the processor being used for executing the application program.

9. The non-transitory, computer-readable medium according to claim 5, wherein the data and second data are processed simultaneously by the execution of the application program.

10. The non-transitory, computer-readable medium according to claim 5, wherein the data and second data are processed subsequently by the execution of the application program.

11. The non-transitory, computer-readable medium according to claim 1, wherein the pre-fetching of the data and the execution of the application program are synchronized.

12. The non-transitory, computer-readable medium according to claim 1, wherein the pre-fetching of the data by the data transfer offloading circuitry is defined by instructions included in the application program.

13. The non-transitory, computer-readable medium according to claim 1, wherein the application program comprises instructions for triggering the pre-fetching of the data by the data transfer offloading circuitry and instructions for performing calculations based on the pre-fetched data.

14. The non-transitory, computer-readable medium according to claim 13, wherein the application program comprises first instructions for triggering the pre-fetching of the data by the data transfer offloading circuitry and second instructions for pre-fetching second data using a core of the processor.

15. The non-transitory, computer-readable medium according to claim 1, wherein the data transfer offloading circuitry of the processor being used to pre-fetch the data is a data streaming accelerator circuitry of the processor.

16. A method for executing an application program on a processor of a computer system, the method comprising:
pre-fetching to a processor cache, using data transfer offloading circuitry of the processor, data being accessed by an application program from a main memory of the computer system; and
executing the application program using the pre-fetched data that is stored in the processor cache.

17. A computer system comprising a main memory, machine-readable instructions comprising an application program, and a processor to execute the machine-readable instructions to:
pre-fetch to a processor cache, using data transfer offloading circuitry of the processor, data being accessed by an application program from a main memory of the computer system; and
execute the application program using the pre-fetched data that is stored in the processor cache.
